(19) United States
(12) Patent Application Publication
(10) Pub. No.: US 2020/0377382 A1
(43) Pub. Date: Dec. 3, 2020

(54) METHOD AND APPARATUS FOR TREATING WASTEWATER USING NON-CHEMICAL PROCESS

(71) Applicant: THE RESEARCH FOUNDATION FOR THE STATE UNIVERSITY OF NEW YORK, Albany, NY (US)

(72) Inventor: Devinder Mahajan, South Setauket, NY (US)

(73) Assignee: THE RESEARCH FOUNDATION FOR THE STATE UNIVERSITY OF NEW YORK, Albany, NY (US)

(21) Appl. No.: 16/890,567

(22) Filed: Jun. 2, 2020

Related U.S. Application Data
(60) Provisional application No. 62/856,437, filed on Jun. 3, 2019.

(51) Int. Cl. C02F 1/22

(52) U.S. Cl. CPC C02F 1/22; C02F 2209/03; C02F 2209/02; C02F 2103/32; C02F 2301/046; C02F 2301/066; C02F 2303/10; C02F 2201/009

(57) ABSTRACT

A method for treating wastewater, comprising: (i) injecting a hydrate-forming gas (e.g., propane) into the wastewater under conditions of elevated pressure and reduced temperature to form a solid hydrate composed of the hydrate-forming gas and water from the wastewater; and (ii) separating the solid hydrate from the wastewater to result in removal of water from the wastewater, thereby resulting in partially dewatered wastewater, and optionally, (iii) lowering the pressure and/or raising the temperature of the solid hydrate to decompose the solid hydrate into reformed hydrate-forming gas and reformed water, and further optionally, recycling the reformed hydrate-forming gas for use in step (i) and/or capturing the reformed water from step (iii) and further decontaminating until suitable for release into waterway or for use in a process. The invention is also directed to an apparatus for practicing the method described above.

### CROSS REFERENCE TO RELATED APPLICATION

The present application claims benefit of U.S. Application No. 62/856,437, filed on Jun. 3, 2019, all of the contents of which are incorporated herein by reference.

### FIELD OF THE INVENTION

The present invention generally relates to the field of wastewater treatment. The present invention is more particularly directed to the treatment of wastewater using non-chemical means, particularly for the dewatering and concentrating of wastewater with simultaneous production of clean water.

### BACKGROUND OF THE INVENTION

As safe and clean water sources continue to dwindle, finding improved methods of wastewater management has become a significant focus of attention. Recycling of wastewater will need to be substantially relied upon in the future as the population is projected to approach 9 billion by 2050. In the United States, despite investments in the Publicly Owned Treatment Works (POTWs) dictated by the Clean Water Act (CWA), point source discharges continue to be a significant contributor to the degradation of surface water quality. Wastewater treatment is energy intensive and accounts for 2% of total U.S. electricity.

Coupled with the CO₂ emissions of 14.8 (MMT), the CO₂-eq. associated with CH₄ releases from organic sludge degradation in wastewater treatment systems amounted to about 0.3% of total U.S. GHG emissions. In 2012, U.S. clean water needs for building new and updated existing wastewater treatment plants alone were $102 billion (U.S. EPA (2016) Clean Watersheds Needs Survey 2012—Report to Congress). This crisis has led to projections of over $74 billion in upgrading of wastewater management systems by 2040 (Failure to Act—The Economic Impact of Current Investment Trends in Water and Wastewater Treatment Infrastructure. A Report of the American Society of Civil Engineers (ASCE), 2011). Two conclusions can be drawn from these data: energy and water are intricately connected; and there is an opportunity for new technology adaptation in the coming years. Water reuse can significantly decrease system energy usage, but that would require development of an economical system that has not yet been developed.

Two main methods are currently in use for treatment and recycling of wastewater: 1) advanced membrane separation; and 2) treatment with chemicals. Due to the colloid stability of highly hydrated microbial aggregation, it is generally difficult to dewater sludge without conditioning operations. Polyacrylamide (PAM), polyferric chloride/polymeric aluminum chloride (PACl), lime and some advanced oxidation processes (AOPs) reagents represented by Fenton/Fenton-like reagents, Fe (II)-activated persulfate, thermal/iron-activated peroxymonosulfate (PMS), and peroxydisulfate (PDS) have been widely used as conditioning reagents in combination with mechanical pressing to enhance the release of interstitial or intracellular water from sludge flocs. However, the introduction of chlorine with conventional conditioning reagents risks formation of dioxin or equipment corrosion in the subsequent thermochemical process. In addition, the dosage of these conditioning reagents can be in the range of 50-100 mg/g dry solid (DS), which results in a substantial volume increase and calorific value reduction of dewatered sludge.

A typical commercial technology is multi-step, such as follows: 1) separation of non-food components; 2) disinfection treatments using chlorination and ultraviolet (UV), both having comparable energy consumption; and 3) chemical additions of ferric salts and lime enhance coagulation and sedimentation processes for improved solids removal as well as removal of toxic pollutants. These steps can be complemented with CH₄ recovery, a step that includes the aeration process, which facilitates microbial degradation of organic matter, and can account for 25% to 60% of the energy use in wastewater treatment plants. Additionally, pumping systems typically add 10-15% of energy cost at wastewater treatment plants. Leachate management in landfills is both a growing operational problem and an increasing cost factor. Leachate constituents can also interfere with standard wastewater processes, making the throughput of leachate at wastewater treatment plants a growing concern.

In order to minimize the negative effects of conditioning reagents, alkaline hydrothermal pretreatment and electrolysis are also combined with drying technologies and electro-dewatering processes (A. Mahmoud et al., Water Res., 45(9), 2795-2810, 2011). However, these processes usually cause deleterious lysis of sludge flocs and substantially increase pollutant concentration in the liquid phase of pretreated sludge (Hu et al., Separ. Purif. Technol., 172, 357-365, 2016). As a result, the wastewater produced from the dewatering units contains high-strength nitrogen and phosphorus and should be recycled back to the influent of WWTPs for further treatment, which will require extra aeration and carbon source to achieve enhanced biological nutrient removal (Hu et al., 2016, Ibid.). Therefore, the realization of an efficient dewatering process with simultaneous clean water extraction can avoid the dependence on conditioning reagents of conventional solid-liquid processes, eliminate the potential secondary pollution, and also minimize the caloric value decrease of dewatered sludge for better closed-circuit energy recycle. However, such an energy efficient process capable of being used cost-effectively and without chemicals on a large scale has not yet been achieved.

### SUMMARY OF THE INVENTION

The present disclosure is foremost directed to a method for treating wastewater using an energy efficient and cost-effective process that does not rely on chemical conversions. In brief, the method relies on the action of a hydrate-forming gas on wastewater, under appropriate conditions for the hydrate-forming gas to form a solid hydrate with water contained in the wastewater, followed by separation of the solid hydrate from the wastewater. The end result is the dewatering of the wastewater. The resulting concentrated wastewater can be again treated with hydrate-forming gas under appropriate conditions to form a solid hydrate with water contained in the concentrated wastewater, thereby further concentrating the wastewater. The process can be repeated, as desired, until sufficiently dewatered (concentrated) wastewater is achieved. The concentrated waste can advantageously be used as fuel, such as in combustion, incineration, pyrolysis, or in the production of biogas or methane. Alternatively, the more concentrated wastewater can be processed by conventional wastewater treatment, except that the conventional process could advantageously use a significantly reduced amount of chemicals in view of the significantly reduced volume of waste. As further discussed below, the solid hydrate may also be decomposed to reform the hydrate-forming gas and water, wherein the reformed hydrate-forming gas may be recycled for re-use in solid hydrate formation and/or the reformed water may be further decontaminated until suitable for release into a waterway or for use in a process.

The method more specifically includes: (i) injecting a hydrate-forming gas into wastewater under conditions of elevated pressure and reduced temperature sufficient to form a solid hydrate (clathrate) composed of the hydrate-forming gas and water from the wastewater; and (ii) separating the solid hydrate from the wastewater to result in removal of water from the wastewater, thereby resulting in partially dewatered wastewater. In some embodiments, the method further comprises: (iii) lowering the pressure and/or raising the temperature of the solid hydrate, as separated from the wastewater in step (ii), to decompose the solid hydrate into reformed hydrate-forming gas and water. In some embodiments, the method further comprises: (iv) capturing the reformed hydrate-forming gas from step (iii) and recycling the reformed hydrate-forming gas back into the start of the process at step (i), i.e., by using the reformed hydrate-forming gas as hydrate-forming gas in step (i). The method may also further comprise: (iv) capturing the reformed water from step (iii) and further decontaminating the reformed water until suitable for release into a waterway or for use in a process.

In another aspect, the instant disclosure is directed to an apparatus for achieving the above-described method for treating wastewater. The apparatus is advantageously useful for continuous wastewater treatment using a non-chemical green process as described above. The apparatus and process provide a pathway in which pure water is separated from dissolved impurities in wastewater by mediation of an non-reactive gas under slightly or moderately cooled conditions. Once separated, water is recovered and the gas is recycled. The extracted water may be suitably cleansed according to its intended end-use.

The apparatus and process described herein provides a non-chemical approach to separate water and dissolved organics and inorganics from wastewater streams. The apparatus and process involve physical phase change of a commonly used gas that can be recycled after each batch. The method can be based, for example, on the addition of propane gas to wastewater under mild pressure and low temperature to cause a phase change by forming a solid propane hydrate. The process results in a solid phase containing concentrated inorganic and organic compounds while the liquid water is drawn to encapsulate gas to form propane hydrate. Exposing the propane hydrate to ambient conditions separates the water from the propane, and the separated water can be passed through biochar or other cleansing system to remove remaining contaminants. The intention is for the aqueous phase to be suitable for discharge to the environment and the solid phase may be further treated to extract methane or other resource. This process requires no chemical reactions or conversions, and is effectively catalytic, unlike other wastewater treatment processes.

The apparatus more particularly include the following components: (i) a container for storing a hydrate-forming gas; (ii) a wastewater treatment vessel for receiving wastewater, wherein the wastewater treatment vessel is sealable and pressure-resistant and has a height at least twice its width and contains a sieve positioned within a lower half of the height and across the width when the wastewater treatment vessel is positioned on a surface with its height perpendicular to the surface, wherein the sieve is capable of retaining macroscopic insoluble matter of the wastewater below the sieve while permitting passage of soluble or microscopic matter above the sieve when wastewater is pumped into the wastewater treatment vessel in the lower half of the height below the sieve; (iii) a first conduit for transporting wastewater from a wastewater source into the wastewater treatment vessel below the sieve; (iv) a second conduit for transporting hydrate-forming gas from the container in (i) to the wastewater treatment vessel; and (v) a cooling device in contact with the pressure-resistant wastewater treatment vessel; wherein the apparatus is capable of supplying sufficient pressure of the hydrate-forming gas and sufficient reduction in temperature in the wastewater treatment vessel to result in formation of solid hydrate matter composed of the hydrate-forming gas and water from the wastewater.

In a particular embodiment, the apparatus and process use propane gas as the clathrate former. The apparatus and process offer a novel solution for separating water from wastewater without reliance on chemical means by using propane gas or other hydrate-forming gas that is recycled. Some key advantages of the process include: 1. no chemicals are used; 2. propane gas (a commonly used household gas) is used to induce water separation as clathrate from wastewater; 3. once separated, the kinetically unstable clathrate automatically decomposes once warmed above 10° C.; and 4. propane gas is recovered and recycled. The process advantageously results in no gas being consumed in the process, and processing losses can be offset by periodically injecting new gas into the system.

### BRIEF DESCRIPTION OF THE FIGURES

FIG. 1 is a schematic of an exemplary apparatus for wastewater treatment using a hydrate-forming gas.

FIG. 2A is a schematic of an exemplary tube reactor apparatus; FIG. 2B is a schematic of an exemplary windowed reactor apparatus.

FIG. 3A is a phase diagram for propane hydrate formation in sewage sludge. FIG. 3B shows FT-IR spectra of dry raw sludge, bound EPS, and soluble EPS.

FIG. 4A is a chart showing mass distribution during a propane-based dewatering process over 15 runs. FIG. 4B is a chart showing volume variation during the propane-based dewatering process over 15 runs.

FIG. 5 is a photograph showing changes in the propane hydrate phase and the concentration of sludge phase in the windowed reactor over 16 batches.

### DETAILED DESCRIPTION OF THE INVENTION

In one aspect, the present disclosure is directed to a method for treating wastewater in which a hydrate-forming gas is injected into the wastewater under conditions suitable for forming a solid hydrate (i.e., “clathrate” or “clathrate hydrate”) composed of the hydrate-forming gas and water contained in the wastewater. The foregoing step may herein be referred to as “step (i)”. As the method of treatment described herein operates by dehydrating wastewater, the method can be generally applied to any type of wastewater. The wastewater can be any from any source, such as municipal (sewage) waste, food production or processing waste, petroleum processing waste, biomass processing waste, or chemical production or processing waste. In particular embodiments, the wastewater is predominantly organic-containing waste rather than predominantly inorganic (e.g., salt-containing) waste. Nevertheless, in some embodiments, the wastewater may contain a substantial amount or otherwise undesirable level of an inorganic salt, such as a nitrate or phosphate. The presently described method may be used to extract purified water from wastewater containing any such species, including one or more inorganic salts.

Solid hydrates are ice-like inclusion compounds that typically form at elevated pressure (e.g., up to a few megapascals) and reduced temperatures (i.e., generally below 25° C.) by combination of water (“host” molecules) and small gas molecules (“guest” molecules). The hydrate-forming gas may be, for example, methane, ethane, propane, butane, or carbon dioxide. The hydrate-forming gas may be a single gas or a combination of two or more of these gases (e.g., propane admixed with one or more of methane, ethane, and/or butane). As well known, the conditions required for forming a solid hydrate vary depending on the hydrate-forming gas being used. For example, methane hydrate can form at a temperature below 25° C. and pressure of 1-5 MPa, whereas propane hydrate can form at a temperature of 0° C.-5° C. and pressure of 170-530 kPa (0.17-0.53 MPa). The conditions for forming such hydrates can be found in the art, such as described in X. Cao et al., Phys. Chem. Chem. Phys., 18, 3272-3279, 2016. The hydrate-forming gas may be injected into the wastewater by any means known in the art, typically by opening of a valve connected to a vessel of the gas maintained under high pressure, wherein the valve controls flow of the gas within a conduit connecting the gas vessel and container holding the wastewater.

Following step (i), the solid hydrate is separated from the wastewater to result in dehydration (removal of some of the water) from the wastewater. The foregoing step may herein be referred to as “step (ii)”. The result is that the wastewater is partially dewatered to result in wastewater containing a higher solids content, i.e., more concentrated wastewater. Generally, the solid hydrate is significantly less dense than the wastewater or even water itself, which results in the solid hydrate floating to the top of the wastewater surface. Thus, any method for removing the floated solid hydrate may be used herein. The solid hydrate may be separated from the wastewater by, for example, manual or mechanical skimming, or by flow (transfer) of the top layer of the wastewater into a separate vessel, such as by a conduit (pipe), wherein the separate vessel may be regulated in pressure and/or temperature to either maintain or decompose the solid hydrate.

If further dewatering of the wastewater is desired, the partially dewatered wastewater produced in step (i) may be again subjected to the above described processes in steps (i) and (ii) of forming a solid hydrate and separating the solid hydrate to yield further dewatered wastewater. More specifically, the following steps may be performed directly after step (ii): (i-a) injecting a hydrate-forming gas into the partially dewatered wastewater under conditions of elevated pressure and reduced temperature to form a solid hydrate composed of the hydrate-forming gas and water from the partially dewatered wastewater; and (ii-a) separating the solid hydrate from the partially dewatered wastewater to result in removal of additional water from the partially dewatered wastewater, wherein steps (i-a) and (ii-a) can be conducted in the same manner as steps (i) and (ii), respectively. In one embodiment, the hydrate-forming gas used in step (i-a) is new (fresh) hydrate-forming gas. In another embodiment, the hydrate-forming gas used in step (i-a) is recycled from the decomposition of solid hydrate after separation of the solid hydrate from the wastewater, as further discussed below. Additional process steps equivalent to steps (i-a) and (ii-a) may be repeated any number of times, e.g., by adding steps (i-b) and (ii-b) directly after step (ii-a), wherein steps (i-b) and (ii-b) are analogous to steps (i-a) and (ii-a).

If desired, the more concentrated wastewater, such as produced after step (ii) or (ii-a), can be processed by conventional wastewater treatment (e.g., conveyed into a conventional wastewater treatment facility), except that the conventional process would advantageously require a significantly reduced amount of chemicals in view of the significantly reduced volume. Alternatively or in addition, the concentrated wastewater can advantageously be used in an energy recovery process, such as a waste-to-fuel or waste-to-energy process. The waste-to-fuel process may be, for example, a gasification or biogasification (anaerobic digestion) process. A gasification process is a thermochemical process conducted under limited oxygen to convert waste to carbon monoxide, hydrogen, and carbon dioxide, otherwise known as syngas, whereas a biogasification process typically produces a mixture of gases that includes methane and carbon dioxide. The waste-to-energy process may be, for example, incineration, pyrolysis, or combustion of fuel (e.g., syngas or biogas) produced by a waste-to-fuel process.

In one embodiment, the solid hydrate, after being separated from the wastewater in step (ii) or step (ii-a) or step (ii-b), is placed in a vessel in which the solid hydrate is subjected to a lower pressure and/or higher temperature sufficient to decompose the solid hydrate back into hydrate-forming gas and water. The reproduced hydrate-forming gas and water are herein referred to as “reformed hydrate-forming gas” and “reformed water,” respectively. In a preferred embodiment, the reformed hydrate-forming gas is captured and recycled for re-use in step (i). Typically, the reformed water is captured and further decontaminated until suitable for release into a waterway or for use in a process. In another embodiment, the solid hydrate, after being separated from the wastewater in step (ii), is discarded, although the latter embodiment is generally not preferable.

In another aspect, the invention is directed to an apparatus for achieving the above-described process. Overall, the apparatus should be capable of supplying sufficient pressure of a hydrate-forming gas and sufficient reduction in temperature in the wastewater treatment vessel (WTV) to result in formation of solid hydrate matter composed of the hydrate-forming gas and water from the wastewater. The apparatus should also be capable of separating the solid hydrate from dehydrated wastewater.

As a first component, the apparatus includes a container or tank for storing the hydrate-forming gas (i.e., “gas tank”). As the gas is typically under pressure, the container or tank should be pressure-resistant and otherwise acceptable for use in containing a pressurized gas. As noted above, the hydrate-forming gas may be a single gas or a combination of two or more of these gases (e.g., propane admixed with one or more of methane, ethane, and/or butane). In some embodiments, the hydrate-forming gas is unpurified (crude) propane, such as extracted from a propane well. Unpurified propane generally contains propane in a predominant amount but generally in admixture with at least carbon dioxide, methane, and butane.

As a second component, the apparatus includes a wastewater treatment vessel (WTV) for receiving wastewater. The WTV is sealable and pressure-resistant. The term “sealable” refers to the presence of at least one openable-closable part, such as a lid or hatch, for the purpose of, for example, charging the WTV with water, and/or for removing dehydrated waste, and/or for removing solid hydrate, and/or for cleaning, adjustment, or repair. When closed (sealed), the WTV should be capable of resisting pressures used for producing the solid hydrate. In order to permit efficient floating and subsequent removal of the solid hydrate, the WTV should have a height at least twice its width (or, for example, at least three, four, or five times its width) from a perspective in which the WTV is positioned on a surface with its height substantially perpendicular to the surface (i.e., substantially parallel to the direction of gravity) and width substantially parallel to the surface. The WTV may be of suitable size to hold at least 10, 20, 50, 100, 200, 500, or 1000 gallons of wastewater at one time while maintaining at least some headspace volume to remove floating hydrate. In order to facilitate the separation of solid sludge material and solid hydrate, the WTV also contains a sieve (filter, grid, or mesh) positioned within a lower half of the height and across the width of the WTV, and a first conduit is present for transporting wastewater from a wastewater source into the WTV below the sieve. When wastewater enters the lower half of the WTV below the sieve, the sieve is capable of retaining macroscopic insoluble matter (e.g., sludge) of the wastewater below the sieve while permitting passage of soluble or microscopic suspended matter above the sieve. Generally, the sieve has a porosity of at least 1, 2, 5, or 10 mm and up to 20, 30, 40, or 50 mm. The sieve can be constructed of any of the materials known in the art known for such use, e.g., metal, ceramic, or hard plastic.

In addition to the first conduit for transporting wastewater from a wastewater source into the WTV below the sieve, the WTV also includes a connection to a second conduit for transporting hydrate-forming gas from the gas tank to the WTV. The second conduit should be connected to the WTV in the lower half of the WTV below the sieve. However, in some embodiments, the WTV is equipped with an additional upper connection point (above the sieve) for the second conduit, in order to periodically introduce hydrate-forming or other gas from the top of the WTV to loosen or flush away debris from the sieve.

The apparatus also includes a cooling device operably connected with the WTV in order to reduce the temperature of the WTV when charged with wastewater to form solid hydrate. The cooling device can be any such device known in the art capable of cooling the internal temperature of a large tank. In some embodiments, the cooling device includes pipes wrapped around the WTV, wherein the pipes transport a cooling liquid or gas. One or more cooling pipes may also be included within the WTV. To avoid hydrate formation in the incoming gas line and at the bottom of the WTV below the sieve, the incoming gas and wastewater liquid line may be wrapped with heating tape to maintain a temperature above where hydrate formation occurs, e.g., between 10° C.-15° C. Generally, the WTV is also operably connected to a temperature monitoring device and/or a pressure monitoring device. The temperature controlling device may also be operably connected to the temperature monitoring device to ensure that the WTV be maintained within a set temperature range. Generally, the pressure in the WTV is controlled by regulating the flow of gas entering the WTV.

The apparatus described above may further include a separation vessel and a third conduit connecting an upper half of the wastewater treatment vessel with the separation vessel. At least one purpose of the third conduit is to transport solid hydrate matter formed in the upper half of the wastewater treatment vessel to the separation vessel. The purpose of the separation vessel is to receive solid hydrate that has floated to the top of the WTV; thus, the separation vessel receives solid hydrate that has been separated from dehydrated wastewater produced in the WTV. Generally, the separation vessel serves to decompose the solid hydrate back into hydrate-forming gas and water, for the purpose of recycling the hydrate-forming gas back into step (i), or for producing cleansed water from wastewater, or for both. If decomposition of the solid hydrate is intended in the separation vessel, the separation vessel should be sealable and sufficiently pressure resistant to withstand pressure build-up resulting from reforming of hydrate-forming gas caused by decomposition of the solid hydrate matter. Where reformed water is intended to be discharged to a waterway or intended for human consumption or other use, the separation vessel may contain a water purifying material (e.g. activated carbon or biochar) and a fourth conduit for transporting purified water from the separation vessel to outside the separation vessel. Where hydrate-forming gas is intended to be recycled, the separation vessel is further connected to a fifth conduit for transporting reformed hydrate-forming gas produced in the separation vessel to the WTV, or the tank holding the hydrate-forming gas, or a separate gas storage tank connected to the WTV, to result in recycling of the hydrate-forming gas.

In some embodiments, the process is a continuous process in which reformed hydrate-forming gas is continuously produced from solid hydrate continuously produced from continuous inflowing wastewater. In other embodiments, the process is a batch process in which successive batches of reformed hydrate-forming gas are produced from solid hydrate produced from set amounts of inflowing wastewater. In either the continuous or successive batch process, the reformed hydrate-forming gas is generally recycled as described above. Nevertheless, as the gas recycling must suffer some amount of process loss, the process should also include the periodic input of fresh hydrate-forming gas to counteract the process loss and maintain a sufficient level of hydrate-forming gas.

The apparatus generally also includes a source of electrical energy, which may be an electrical energy device, connected to the cooling device or any other component of the apparatus requiring energy to operate (e.g., pump). In some embodiments, the electrical energy device is a renewable energy device, such as a solar panel, wind turbine, geothermal generator, fuel cell, or biogas electricity generator.

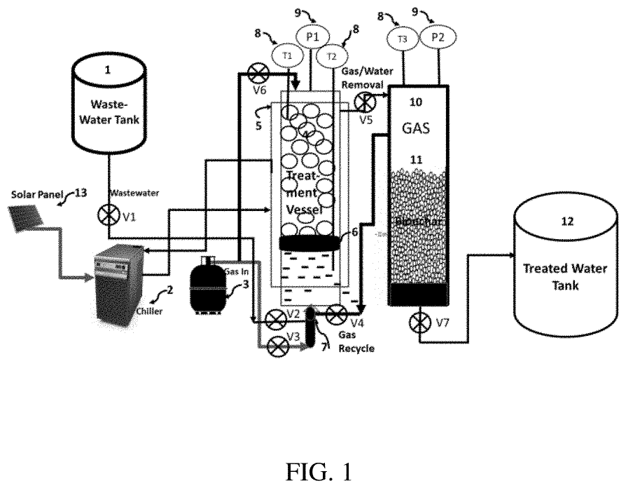

A schematic of an exemplary apparatus is provided in FIG. 1. The wastewater from the storage tank (1) is pumped into the treatment vessel (4) from the bottom. Treatment vessel (4) has a unique configuration: at two-thirds down, a sieve (6) is placed that allows only impure water with dissolved and small undissolved impurities to pass through. The sieve size can be selected to be specifically selective as to what can pass through. Once the wastewater is pumped at a certain level, valves V1 and V2 are closed and gas from gas tank (3) is introduced through a bubbler from the bottom of the vessel (4). The gas is introduced through valve V3 until the vessel (4) pressure reaches up to 70 psig, and then valve V3 is closed. The pressure can be varied from 15 psig to up to 100 psig, depending on the temperature and pressure conditions. After pressurization, the chiller (2) is turned and the chilled fluid (normally antifreeze) is circulated through the vessel jacket (6) until the vessel (4) temperature reaches between 2° C.-5° C. The treatment vessel (4) is kept at this temperature until a white solid ice-looking material (i.e., solid hydrate) forms inside the treatment vessel (4). At this point, the gas pressure starts to drop and more water inside the vessel turns in to solid. This liquid-to-solid phase change may take from 10-60 minutes. The gas from gas tank (3) is bubbled periodically to make up for the pressure drop inside to maintain the vessel pressure to between 30 psig to below 100 psig. The temperature of the gas phase and liquid phases of vessel (4) is continuously recorded by thermocouples T1(8) and T2 (8) while the pressure gauge P1 (9) records the pressure.

After most of the water has turned into a solid mass that floats on the top in the treatment vessel (4), the solid/water slurry is transferred into the separation vessel (10) simply by slowly opening valve V5. The slurry transfers into the separation vessel (10) due to the pressure difference. The temperature of vessel 10 is ambient and that allows the solid hydrate in the slurry to decompose into water and gas. Both temperature and pressure of the separation vessel (10) is measured with thermocouple T3 and P2, respectively. The gas is recycled by opening valve V4. The remaining water passes a bed of biochar (11) to remove any trace impurities. The pure water is drained through valve V7 and stored in the treated water tank (12). The cycle is repeated as more wastewater is pumped into treatment vessel (4). For periodically cleaning of sieve (6), the gas inlet is switched from V2 to V6 for a period of time and switched back to valve V2.

The apparatus and process are unique in multiple aspects, as follows:

1. The present wastewater treatment process is disruptive because the treatment is based on attracting pure water out of the waste, thereby leaving concentrated multiple impurities behind. The conventional systems use multiple impurity-specific chemicals. Moreover, the conventional systems use a large quantity of chemicals to neutralize impurities in dilute streams. The present process does not require such chemicals.

2. The present system is a one-step process that is achieved in two vessels: first, pure water is drawn by the hydrate-forming gas to form a solid material that floats at the top of the wastewater surface due to density differences in the treatment vessel. Second, the solid material is transferred as a slurry to the second vessel (gas separation vessel). In this step, the phase change occurs simply by warming to 10° C. or higher (e.g., room temperature). The released water filters through the biochar bed to substantially remove any trace impurities, such as any carried over during transfer from vessel 5 to vessel 10.

3. The unit can operate as stand-alone or mobile. For example, the apparatus can be mounted on a flatbed truck and moved around from wastewater site-to-site as needed to conduct wastewater treatment. The mobile system is completely self-sufficient (i.e., autonomous) with the needed utilities provided by an off-grid power source, such as solar panels.

4. The power needed to operate the modular system could be provided by installing solar panels or other energy renewable device. An energy renewable system makes the entire system independent and versatile.

Examples have been set forth below for the purpose of illustration and to describe certain specific embodiments of the invention. However, the scope of this invention is not to be in any way limited by the examples set forth herein.

### EXAMPLES

Because the equilibrium pressure of propane hydrates is relatively lower than those of other common guest molecules of clathrate hydrates, such as methane, ethane, and carbon dioxide, the following experiments aimed at exploring the potential of using propane as a water extractant to achieve enhanced dewatering of sludge. A particular advantage of propane hydrate-based dewatering is that propane exists as a gas at room temperature and ambient pressure. It has a strong affinity to force water molecules to form cages, resulting in facile formation of hydrates under 170-530 kPa and at temperatures of 273.15-278.15 K. This can be also verified by using the molar Gibbs free energy of −214.3 kJ/mol at 278.15K for the following reaction (Jr and Koh, Clathrate Hydrates of Natural Gases. CRC Press, Boca Raton, Fla., USA. 2008):

C₃H₈+17H₂O=C₃H₈.17H₂O (1)

Another advantage of propane hydrate-based dewatering is that continuous and dense propane hydrate formation mainly takes place on the gas-liquid interface exchange for extracting water and the formed hydrates float up to the sludge surface due to its lower density (about 0.7-0.8 cm3/g) than water (Jr and Koh, 2008). After the quick downward discharge of dewatered sludge, propane hydrates are also gradually decomposed by depressurization, and the released propane can be collected for direct multiple recycles or indirect reuse after being easily purified by pressurized liquefaction, which avoids the resource consumption associated with conventional non-renewable conditioning reagents. The substantially dewatered sludge can be subsequently utilized as solid fuel for energy recovery. Therefore, in situ propane hydrate formation can provide an incineration, pyrolysis, or gasification feedstock without external addition of pretreatment reagents. It should also significantly reduce the negative impacts of conventional conditioning methods and advance the implementation of green operation for WWTPs.

Sewage sludge and extracellular polymeric substances (EPS) analysis

Sewage sludge samples were obtained from a wastewater treatment plant located in Northport, N.Y., USA that uses an anaerobic/anoxia/aerobic (A2/O) process and has a design capacity of 1500 m³/day. The three parallel samples were collected at 24 h intervals and treated as one mixed sample. The sludge samples had the following general characteristics: pH: 6.68±0.02; water content: 98.81±0.01 wt. % and by difference, total solid: 1.19±0.01 wt. % (including volatile solid: 0.96±0.01 wt. %); sludge volume index (SVI): 183.11±0.11 mL/g. The methods for EPS extraction and Fourier transform infrared spectroscopy analysis are based on established methods.

Tube Reactor

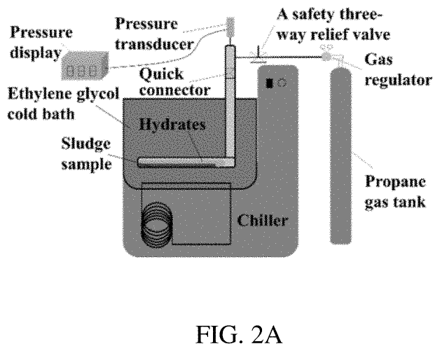

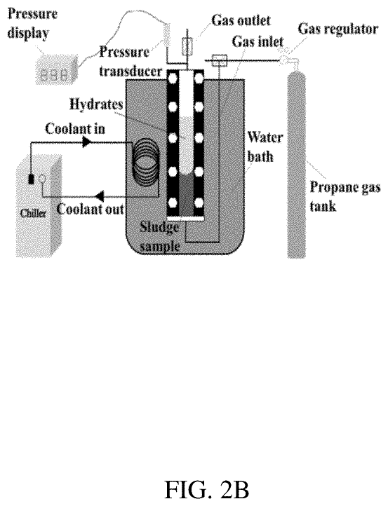

In order to accurately control and monitor the temperature and gas pressure, the phase diagram of propane hydrates in sewage sludge was determined by a small-volume tube reactor using a high precision chiller. The high-pressure cell was fabricated from a 304 stainless steel tube (9 mm internal diameter, total volume 10 cm³). A schematic of the tube reactor is provided in FIG. 2A. The bottom of the tube could be plugged or used to insert a thermocouple. The top was connected to a stainless steel quick connect for loading the sample. A safety three-way relief valve was employed to release pressure from the system at any time during the experiment. The appropriate temperature for propane hydrate formation was maintained by a chiller filled with ethylene glycol. The chiller was fitted with a high-precision temperature control system and the estimated error of temperature measurement was ±0.01 K. The fluctuation of the temperature control was ±0.03 K. The pressure value was recorded with a pressure transducer and the estimated error was ±5 kPa.

Windowed Reactor

A reactor fitted with see-through windows (30 cm high; 1.5 cm wide) along the reactor length on opposite sides was used for the propane hydrate-based dewatering, because it was ideal to observe the separation of hydrate and sludge phases during the propane hydrate formation. A schematic of the windowed reactor is provided in FIG. 2B. The height and inner diameter were 34 cm and 5 cm, respectively. The total reactor volume was about 667 mL. A water bath was used to maintain the appropriate temperature. A pressure transducer (measurement accuracy: ±5 kPa) and thermocouple (measurement accuracy: ±0.1 K) were installed at the top and bottom of the windowed reactor, respectively. Ethylene glycol was used as coolant and pumped by the chiller into the cooling tube, which was submerged in the water bath to maintain the reaction system at a desired temperature 275.2±0.5 K.

Determining phase diagram of propane hydrates formed in sewage sludge

The simulated prediction of equilibrium conditions for propane hydrates in pure water was conducted using the CSMHYD program developed by Colorado School of Mines, Golden, Colo., USA. The commonly-used “pressure search” method was modified to determine the incipience of propane hydrate formation in sewage sludge (Peng et al., J. Nat. Gas Chem., 19(1), 81-85, 2010).

Typical procedures for hydrate-based sludge dewatering and hydrated water sampling

In order to visualize the separation performance of propane hydrates from sludge, the dewatering process was conducted in the windowed reactor described above. The reactor with 200 mL sludge sample in it was cooled until it reached a temperature of 275.2±0.5 K and then the temperature was maintained. During the dewatering process, 40 mL hydrated water was sampled for water quality analysis. But 40 mL raw sludge was also injected to make the headspace volume for the propane gas unchanged with the water sampling.

Hydrated Water Quality Analysis

The chemical oxygen demand (COD), total nitrogen (TN) and total phosphorous (TP) of the water samples from the hydrate-based dewatering process and the supernatant from 30 min settling of raw sludge in a 1 L cylinder were measured using the Hach method (Hach company, USA) in duplicate. In order to evaluate whether the hydrated water can be directly discharged, the measured results were compared and were found to conform to the typical effluent qualities of WWTPs in the United States and Europe.

Phase diagram of propane hydrates in sewage sludge

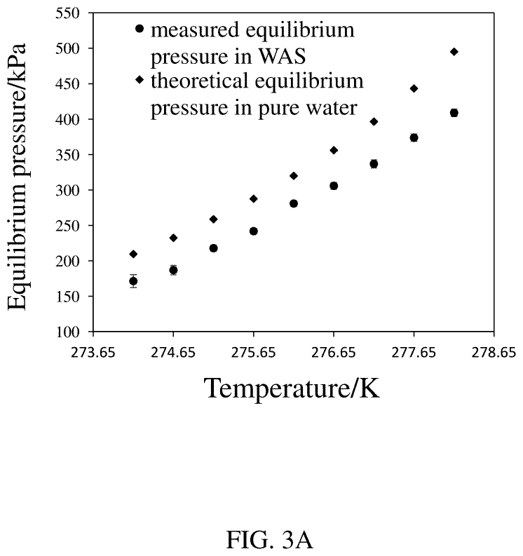

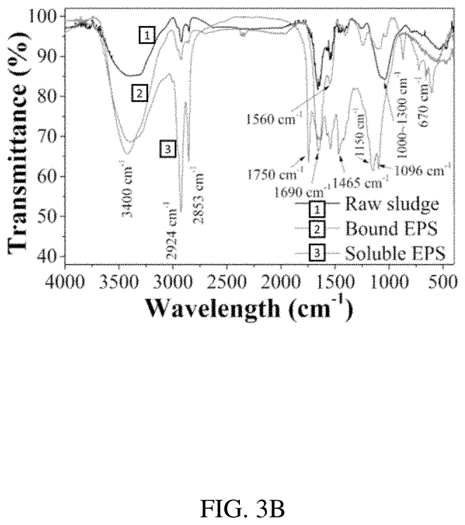

The phase diagram is a useful tool for choosing the appropriate temperature for the hydrate-based dewatering of sludge considering operation feasibility and energy consumption. From FIG. 3A, it can be seen that the presence of sludge flocs promoted the formation of propane hydrates. The equilibrium pressure of propane hydrates in sewage sludge was measured to be lower than its theoretical value in pure water. The sludge flocs were composed of cell aggregations and the surrounding EPS (Sponza, Process Biochem., 37(9), 983-998, 2002). FT-IR spectra shown in FIG. 3B confirmed the presence of carboxyl groups (1690-1750 cm⁻¹, C═O stretch of carboxylic acids), hydroxyl group (3200-3500 cm⁻¹, H-bonded O—H stretch) and ammonia groups (1580-1650 cm⁻¹, N—H bend of amine) of EPS. Due to these very hydrophilic functional groups, a large amount of interstitial water and interfacial water were bound in the fine pores of the porous and net-like sludge flocs as discontinuously distributed phase (Li et al., Water Res., 41(5), 1022-1030, 2007). Once the propane gas was charged into the tube reactor at the appropriate temperature of 273.15-277.15 K, the water trapped in sludge flocs could be converted into dispersed hydrates particles. When these first hydrate particles were formed surrounding sludge floc particles, the organic macromolecules in sludge flocs may continuously confer anti-agglomeration properties to those hydrate particles. Therefore, the presence of sludge particles actually acted as nucleation sites, preventing the agglomeration of formed hydrates and providing more possibilities for the gas-liquid exchanges (Ricaurte et al., Ind. Eng. Chem. Res., 52(2), 899-910, 2013). As a consequence, the crystallization reactions among the guest molecules, propane, and the host molecules, water, were accelerated and promoted.

Except for proteins and carbohydrates as the main components of EPS (More et al., J. Environ. Manag., 144(1), 1-25, 2014), some other complex macromolecules containing various functional groups with different ionization characteristics and electrophilic properties are commonly detected in sludge, e.g. heteropolysaccharides, such as alginate, xanthan, gellan and hyaluronic acid; humic acid and fulvic acid (More et al., 2014, Ibid.); surfactant/vesicant from industrial pollution source such as phospholipid, sodium alkyl sulfate, octadecanoic acid or biosurfactants, rhamnolipid (Soberon-Chavez et al., Appl. Microbiol. Biotechnol., 68(6), 718-725, 2005) or small molecules (peptide: L(+)-Cysteine or glutamate) (Flemming et al., Nat. Rev. Microbiol., 8(9), 623-633, 2010). In this study, cyclic ether (C—O stretch, strong peak at 1000-1300 cm⁻¹) (Czaczyk et al., Pol. J. Environ. Stud., 16(6), 799-806, 2007), sulfate group (S=0 deformation vibration, peaks at 1096 cm⁻¹, 1122 cm⁻¹, and 1150-1250 cm⁻¹) (Soberon-Chavez et al., 2005, Ibid.), and aromatic groups (1465 cm⁻¹, C—C stretch in aromatic ring) (Zhou et al., Sci. Rep., 6(1), 32998, 2016) were detected in raw sludge and soluble EPS, respectively (FIG. 3B).

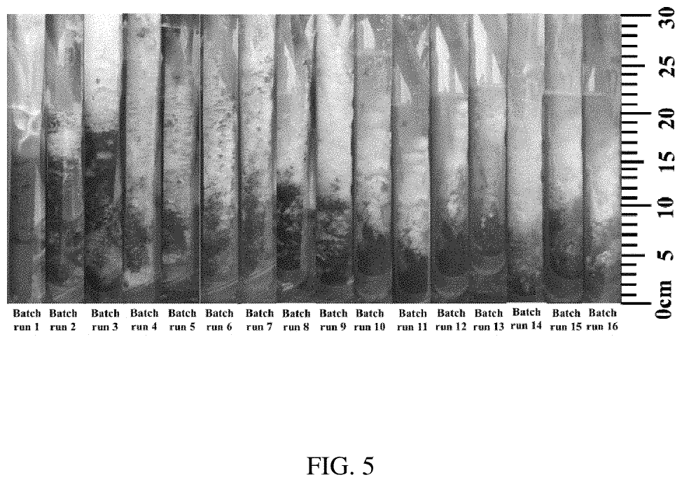

Sulfate group or cyclic ether could be adsorbed on the surface of formed hydrates. As a result, by preventing (or limiting) the agglomeration of hydrate particles, the hydrophilic/hydrophobic groups of EPS helped form a “porous hydrate open structure” that is able to pump the water by capillarity action (Ricaurte et al., 2013, Ibid.). This process is similar to the hydrate formation process in water with sodium dodecyl sulfate (SDS) and tetrahydrofuran (THF) (Lo et al., J. Phys. Chem. C, 114(31), 13385-13389, 2010). The porosity of formed hydrates could also enhance the gas/liquid/solid exchanges and permit a high water to hydrate conversion ratio even in quiescent conditions (Gayet et al., Chem. Eng. Sci., 60(21), 5751-5758, 2005; Zhang et al., Ind. Eng. Chem. Res., 48(13), 5934-5942, 2013). The porous structure, accumulated principally along the cold reactor walls, was also apparent and persisted long enough to be visualized through the reactor windows during the dewatering process (FIG. 5, batch runs 5 and 6). In total, it can be deduced that the nucleation-effect and surfactant-effect of sludge flocs jointly contributed to hydrate formation in sewage sludge and led to the observed drop of equilibrium pressure compared with that in pure water.

Application potential of propane hydrate formation in enhanced dewatering of sewage sludge

The application potential of propane hydrate formation in enhanced dewatering of sewage sludge was validated in terms of the water extraction capacity by propane under free-conditioning conditions and also the visual hydrate-sludge separation performance.

Water conversion efficiency of propane hydrate-based dewatering

The water conversion efficiency was investigated based on the water distribution between sludge and hydrate phase, which would verify the water removal capacity of propane hydrate-based dewatering under free-conditioning conditions. The propane amount in gas phase was determined by monitoring the partial pressure of propane, and accordingly, the amount of converted water and residual water in each batch run can be determined based on the propane consumption. As the density of propane hydrate is lower than water, the conversion of water into hydrates leads to volume compression of headspace for the propane gas phase (Jr and Koh, 2008, Ibid.). The quantification of converted propane in each batch run was conducted while considering this volume reduction of the gas phase.

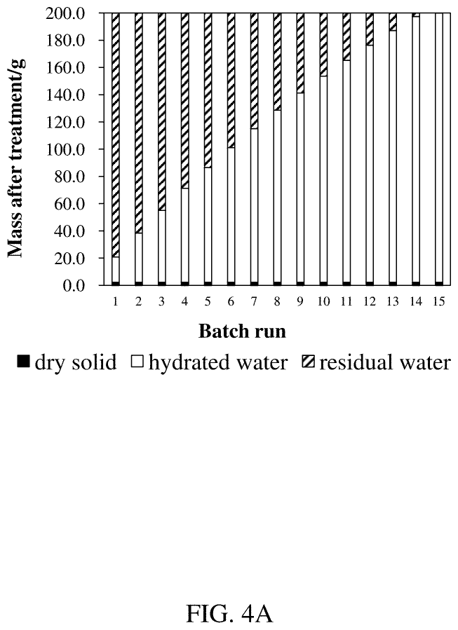

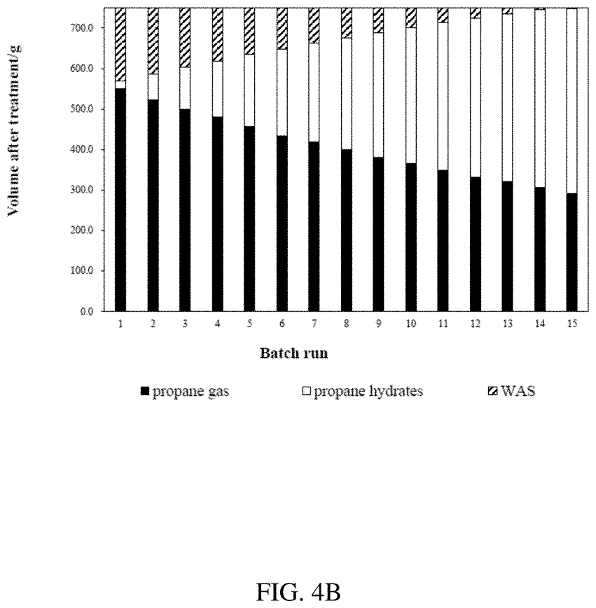

The end pressure of each batch run was recorded as shown in FIG. 4A. In the first 14 batch runs, the final pressure of propane were all measured to be 207±5 kPa and it took about 30 min to see the pressure drop from the initial pressure, 448±5 kPa to the finally constant value. But in batch run 15, the propane pressure only dropped from 448 kPa to 403 kPa, even though the process lasted for 24 h. The initial gas volume, Vᵢ, at the beginning of the batch run i, should be equal to the final gas volume of batch run i−1, Vᵢ₋₁′.

The moles of converted propane can be expressed as

Δnᵢ=nᵢ−nᵢ′=(PVᵢ−P′Vᵢ′)/RT₂ (2)

where nᵢ and nᵢ′ are the initial and final moles of propane in batch run i, respectively; R is the universal gas constant (8.314 J/mol.K); T₂ is the experimental temperature (275.2 K); P and P′ are the initial and the final pressure of propane in each batch run. The mass of water converted into hydrates is calculated according to the stoichiometry ratio of the reaction shown in equation (1). Therefore, the mass of converted water in batch run i is expressed as

Δmᵢ=17ΔnᵢM_{H2O} (3)

Considering the volume expansion of non-gas phase due to the formation of propane hydrates, the final gas volume of batch run i is

Vᵢ′=Vᵢ−(nᵢ−nᵢ′)·(M_{propane hydrates/ρ propane hydrates}−17M_{H2O}/ρ_{H2O}) (4)

where M_{propane hydrates} and M_{H2O} are the molar mass of propane hydrates (350 g/mol) and the molar mass of water (18 g/mol), respectively. ρ_{propane hydrates} and ρ_{H2O} are the density of propane hydrates (typical value: 0.8 g/cm³) and water, respectively. After solving equations (2) and (4) simultaneously, it can be calculated that:

Δmᵢ=17Δnᵢ·M_{H}_{₂}_{O}

where M_{H}_{₂}_{O} is the molar mass of water (18 g/mol).

Therefore, based on equations (2), (3) and (5), the amount of hydrated water after each batch run is also shown in FIG. 4A. Accordingly, the first 14 batch runs totally converted 195.3 g water into propane hydrates. By the dewatering process, in total, 240 mL sludge samples containing 2.86 g dry solid was loaded into the reactor and excluding 195.3 g hydrated water and the water taken out by water sampling steps, only 2.3 g water was residual in the sludge phase after 14 batch runs. Therefore, the water content of the sludge sample was decreased to 44.3 wt. % at the end of batch run 14. Also, the pressure drop or the amount of converted propane in the 15th batch run amounted to 2.3 g of the residual water. Additionally, after re-pressurizing the reactor to 448 kPa in batch run 16, no obvious pressure drop was observed. The above results indicate that the in situ formation of propane hydrate has the ability to realize the full conversion of water in sludge under free-conditioning conditions. In addition, it is notable that the reduction of extracellular water substantially increased the osmotic pressure difference between cell inside and outside. As a result, cell swelling caused the cell lysis and further decreased the sludge water content by converting intracellular water into propane hydrates. Thus, substantial and efficient removal of water from sewage sludge based on propane hydrate formation has herein shown to be feasible.

Time resolved visual observations of separation performance in propane hydrate-based dewatering

The separation of formed propane hydrates and dewatered is shown in FIG. 5. The hydrate-based dewatering process of sewage sludge is, in effect, an extraction process in which the extract is water and the extractant is propane. By injecting the propane gas extractant into sewage sludge under high-pressure and low-temperature conditions, propane gas captured water in the form of homogeneous propane hydrate crystals, which effectively decreased the water content of sewage sludge. Therefore, with increasing amount of formed propane hydrates, the volume of sludge was reduced and the propane hydrates-sludge interface was observed to move down gradually.

Furthermore, most of the formed propane hydrates accumulated upon the sludge-gas interface, which indicated that the crystallization process mainly occurred at the interface between gas and liquid phase, and the separation of hydrates and sludge could be realized spontaneously. Nevertheless, after 88.7 g water (nearly half of the original water content in the sludge sample) was converted into the hydrate phase in the first 6 batch runs, it was observed that some formed hydrates mixed into the sludge. That phenomenon may be due to a significant decrease in the fluidity of sludge samples with the decreased water content. The substantially decreased fluidity had an adverse effect on the separation of hydrates from sludge. However, the re-injections of raw sludge at the end of batch run 3, 6, 9 and 12 were effective to force the floatation of hydrates by offering the local fluidity state in the sludge phase, which was also especially verified by the improvement of hydrate and sludge separation in batch run 10 compared with batch run 9. Also, injecting propane into the sludge phase before each batch run may enhance the separation. In addition, the strong hydrogen bonds separating the water molecules in the hydrate result in a solid density of the hydrate less than that of the liquid. In ice, only 34% of the volume is occupied by water molecules, in contrast to the 37% volume occupation by water molecules in liquid water; this explains the unusual property of a decrease in density upon freezing and accounts for the tendency that the formed propane hydrates float up from the sludge phase.

Potential of propane hydrate-based dewatering for implementing the green operation of WWTPs—Clean water discharge

The hydrated water was sampled by the decomposition of formed propane hydrates after batch runs 3, 6, 9 and 12. The results of water quality analysis are listed in Table 1 below.

TABLE 1
Contamination index of water extracted from
WAS by formation of propane hydrates

| | | COD | TN | TP |
|---|---|---|---|---|
| | | mg/L | mg/L | mg/L |
| Initial WAS water sample | | 327.5 ± 8 | 130.5 ± 4 | 4.3 ± 0.2 |
| after 30 min settling | | | | |
| Water samples | batch run 3 | 51 ± 6 | 19.0 ± 0.7 | 0.4 ± 0 |
| from propane | batch run 6 | 36 ± 2 | 11.5 ± 0.5 | undetected |
| hydrate | batch run 9 | 23 ± 1 | 11.2 ± 0.5 | undetected |
| decomposition | batch run 12 | 21 ± 1 | 10.5 ± 0.2 | undetected |
| EPA Standard | | <250 | 2-6 | 0.010-0.040 |

Since the sludge sample was collected from a pre-anaerobic tank for subsequent anaerobic digestion process, the hydrolysis of proteins and polysaccharides in sludge and the solubilization of the sludge solid phase led to an increase of soluble organic fractions in the liquid phase. The WWTPs in United States and European countries adopt a wide range of standard limits according to the environmental capacity of corresponding receiving water bodies. Though the quality of hydrated water in this study were in agreement with the typical effluent quality of WWTPs for COD, TN and TP set by the United States Environmental Protection agency (US EPA) and European countries. Therefore, the results indicate that the water produced from the decomposition of propane hydrates can be discharged directly without further treatments, which also indicates an excellent separation performance in the presently described hydrate-based dewatering process. The water decomposed from the formed hydrates should be pure water theoretically, but as mentioned earlier, due to the hydrophilicity of protein or heteropolyssacharides of EPS, these macromolecules may absorb on the hydrate particles and lead to the mixing of sludge components and formed hydrates. During propane hydrate formation, the hydrate particles gradually agglomerate to form a homogeneous hydrate phase, and the fine sludge particles would be excluded. It can be seen from FIG. 5 that compared with batch runs 5 or 6, less sludge agglomerates or visible pores can be identified in the hydrates at batch runs 11, 14 and 15. With a prolonged dewatering process, the hydrates tended to be mixed with the sludge, thus showing a continuous homogeneous phase instead of discrete hydrate particles

While there have been shown and described what are at present considered the preferred embodiments of the invention, those skilled in the art may make various changes and modifications which remain within the scope of the invention defined by the appended claims.

What is claimed is:

1. A method for treating wastewater, comprising:
(i) injecting a hydrate-forming gas into the wastewater under conditions of elevated pressure and reduced temperature to form a solid hydrate composed of the hydrate-forming gas and water from the wastewater; and
(ii) separating the solid hydrate from the wastewater to result in removal of water from the wastewater, thereby resulting in partially dewatered wastewater.

2. The method of claim 1, further comprising:
(iii) lowering the pressure and/or raising the temperature of the solid hydrate to decompose the solid hydrate into reformed hydrate-forming gas and reformed water.

3. The method of claim 2, further comprising:
(iv) capturing the reformed hydrate-forming gas from step (iii) and recycling the reformed hydrate-forming gas by using the reformed hydrate-forming gas as hydrate-forming gas in step (i).

4. The method of claim 2, further comprising:
(iv) capturing the reformed water from step (iii) and further decontaminating until suitable for release into waterway or for use in a process.

5. The method of claim 1, further comprising, after step (ii):
(i-a) injecting a hydrate-forming gas into the partially dewatered wastewater under conditions of elevated pressure and reduced temperature to form a solid hydrate composed of the hydrate-forming gas and water from the partially dewatered wastewater; and
(ii-a) separating the solid hydrate from the partially dewatered wastewater to result in removal of additional water from the partially dewatered wastewater.

6. The method of claim 1, further comprising, after step (ii), conveying the partially dewatered wastewater into a conventional wastewater treatment facility wherein the partially dewatered wastewater is treated by conventional means.

7. The method of claim 1, further comprising, after step (ii), using the partially dewatered wastewater as fuel in an energy recovery process.

8. The method of claim 7, wherein the energy recovery process is selected from the group consisting of incineration, pyrolysis, and gasification.

9. The method of claim 1, wherein the wastewater is organic-based.

10. The method of claim 9, wherein the organic-based wastewater is selected from the group consisting of sewage, food production wastewater, biomass processing wastewater, petroleum processing wastewater, and nitrate-containing wastewater.

11. The method of claim 1, wherein the hydrate-forming gas is a single hydrate-forming gas.

12. The method of claim 1, wherein the hydrate-forming gas is a mixture of hydrate-forming gases.

13. The method of claim 1, wherein the hydrate-forming gas comprises propane.

14. The method of claim 13, wherein step (i) comprises injecting propane into the wastewater under conditions of 170-530 kPa and 0° C.-5° C. to form a solid hydrate composed of the propane and water from the wastewater.

15. The method of claim 1, wherein, in step (ii), the solid hydrate is separated from the wastewater by allowing the solid hydrate to float to the surface of the wastewater, and skimming the solid hydrate from the surface.

16. An apparatus for treating wastewater, the apparatus comprising:
(i) a container for storing a hydrate-forming gas;
(ii) a wastewater treatment vessel for receiving wastewater, wherein the wastewater treatment vessel is sealable and pressure-resistant and has a height at least twice its width and contains a sieve positioned within a lower half of the height and across the width when the wastewater treatment vessel is positioned on a surface with its height perpendicular to the surface, wherein the sieve is capable of retaining macroscopic insoluble matter of the wastewater below the sieve while permitting passage of soluble or microscopic matter above the sieve when wastewater is pumped into the wastewater treatment vessel in the lower half of the height below the sieve;
(iii) a first conduit for transporting wastewater from a wastewater source into the wastewater treatment vessel below the sieve;
(iv) a second conduit for transporting hydrate-forming gas from the container in (i) to the wastewater treatment vessel; and
(v) a cooling device in contact with the pressure-resistant wastewater treatment vessel;
wherein the apparatus is capable of supplying sufficient pressure of the hydrate-forming gas and sufficient reduction in temperature in the wastewater treatment vessel to result in formation of solid hydrate matter composed of the hydrate-forming gas and water from the wastewater.

17. The apparatus of claim 16, wherein the apparatus further comprises a separation vessel equipped with a third conduit connecting an upper half of the wastewater treatment vessel with the separation vessel, wherein the third conduit is capable of transporting solid hydrate matter formed in the upper half of the wastewater treatment vessel to the separation vessel.

18. The apparatus of claim 17, wherein the separation vessel contains a water purifying material and a fourth conduit for transporting purified water from the separation vessel to outside the separation vessel.

19. The apparatus of claim 17, wherein the separation vessel is sealable and sufficiently pressure resistant to withstand pressure build-up resulting from reforming of hydrate-forming gas caused by decomposition of the solid hydrate matter, and wherein the separation vessel is connected to a fifth conduit for transporting reformed hydrate-forming gas produced in the separation vessel to the wastewater treatment vessel for recycling of the hydrate-forming gas.

20. The apparatus of claim 16, further comprising a pressure monitoring device for monitoring pressure in the wastewater treatment vessel.

21. The apparatus of claim 16, further comprising a temperature monitoring device for monitoring temperature in the wastewater treatment vessel.

22. The apparatus of claim 16, further comprising an electrical energy device connected to the cooling device.

23. The apparatus of claim 22, wherein the electrical energy device is a renewable energy device.

24. The apparatus of claim 23, wherein the renewable energy device is a solar panel.

25. The apparatus of claim 16, wherein the second conduit for transporting hydrate-forming gas connects the container in (i) to the wastewater treatment vessel below the sieve.

26. The apparatus of claim 16, wherein the apparatus is mobile and capable of rapid deployment to a site where wastewater treatment is needed.
